(19) United States
(12) Patent Application Publication
(10) Pub. No.: US 2006/0112566 A1
(43) Pub. Date: Jun. 1, 2006

(54) Fiber cement shear

(76) Inventors: Eric Lee Peterson, Maple Lake, MN (US); Thomas Andrew Batho, South Haven, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 11/000,480

(22) Filed: Nov. 30, 2004

(51) Int. Cl. B26B 13/00

(52) U.S. Cl. 30/194

(57) ABSTRACT

A hand tool for shearing a fiber cement workpiece and attachable to a drill having a drill chuck has a shearing head having a blade to contact and shear the workpiece; and a coupler connected to the shearing head and imparting reciprocating motion to the blade. The shearing head has a skid plate to contact the workpiece and an enclosed aperture through which the blade reciprocates.

### BACKGROUND OF THE INVENTION

The present invention relates to a hand-held tool for cutting fiber cement siding used in the construction of buildings.

The exteriors of houses and other types of buildings are commonly covered with siding materials that protect the internal structures from external environmental elements. The siding materials are typically planks or panels composed of wood, concrete, brick, aluminum, stucco, wood composites or fiber-cement composites. Wood siding is popular, but it is costly and flammable. Wood siding also cracks causing unsightly defects, and it is subject to infestation by insects. Aluminum is also popular, but it deforms easily, expands and contracts in extreme climates and is relatively expensive. Brick and stucco are also popular in certain regions of the country, but they are costly and labor intensive to install.

Fiber-cements siding (FCS) offers several advantages compared to other types of siding materials. FCS is made from a mixture of cement, silica sand, cellulose and a binder. To form FCS siding products, a liquid fiber-cement mixture is pressed and then cured to form FCS planks, panels and boards. FCS is advantageous because it is non-flammable, weatherproof, and relatively inexpensive to manufacture. Moreover, FCS does not rot or become infested by insects. FCS is also advantageous because it may be formed with simulated wood grains or other ornamental designs to enhance the appearance of a building. To install FCS, a siding contractor cuts the panels or planks to a desired length at a particular job site. The siding contractor then abuts one edge of an FCS piece next to another and nails the cut FCS pieces to the structure. After the FCS is installed, trim materials may be attached to the structure and the FCS may be painted.

Although FCS offers many advantages over other siding materials, it is difficult and expensive to cut. Siding contractors often cut FCS with a circular saw having an abrasive disk. Cutting FCS with an abrasive disk, however, generates large amounts of very fine dust that creates a very unpleasant working environment Siding contractors also cut FCS with shears having opposing blades, as set forth in U.S. Pat. No. 5,570,678 and U.S. Pat. No. 5,722,386 which are herein incorporated by reference. Although the shears set forth in these patents cut a clean edge in FCS without producing dust, many siding contractors prefer to use a hand-held tool because they are accustomed to cutting siding with handsaws. Therefore, in light of the positive characteristics of FCS and the need for a hand-held cutting tool, it would be desirable to develop a hand-held cutting tool that quickly cuts clean edges through FCS without producing dust.

U.S. Pat. No. 6,250,998 (herein incorporated by reference) discloses a hand-held cutting tool for cutting fiber. However, this tool has guide fingers 60a, 60b between which the cutting member 70 reciprocates. Applicant has found that these guide fingers can be eliminated, making the tool simpler to manufacture and to use. Additionally, the present invention provides a skid plate with a reinforced housing to support the skid plate. In the present invention, the fiber cement is sheared between the edges of a an enclosed aperture in the bottom of the skid plate, rather than between an edge of the blade and the interior of a guide finger, as in the '998 patent. Applicant believes that the tool will have longer life than the tool of the '998 patent, since the skid plate with aperture is of stronger construction than the guide fingers.

There is furthermore a need for the blade and skid plate of the tool to be replaceable when worn, and there is a need for the skid plate to be reversible to accommodate wear.

### SUMMARY OF THE INVENTION

A hand tool for shearing a fiber cement workpiece, comprising:
(a) a shearing head having a blade contacting and shearing the workpiece; and
(b) a coupler connected to the shearing head and imparting reciprocating motion to the blade;
(c) wherein the shearing head further comprises a skid plate having an enclosed aperture through which the blade reciprocates.

A principal object and advantage of the present invention is that it has no guide fingers for the blade, thus being simpler to manufacture and less prone to failure.

Another principal object and advantage of the present invention is that it has a wide skid plate that stabilizes the tool during cutting to ensure a straight and even cut.

Another principal object and advantage of the present invention is that the skid plate is reversible to accommodate wear.

Another principal object and advantage of the present invention is that the cutting blade and skid plate are replaceable.

Another object and advantage of the present invention is that the drive shaft has flats to prevent the drill chuck from slipping.

Another principal object and advantage of the present invention is that it has a ball bearing drive system.

### BRIEF DESCRIPTION OF DRAWINGS

FIG. 1 is a perspective view of the hand tool of the present invention, with a drill shown in phantom and with some parts cut away to show internal structure.

FIG. 2 is a side elevation view of the hand tool of the present invention with some parts cut away to show internal structure.

FIG. 3 is a top plan view of the hand tool of the present invention.

FIG. 4 is a bottom plan view of the hand tool of the present invention.

FIG. 5 is a side exploded view of the shearing head of the hand tool of the present invention.

FIG. 6 is a top exploded view of the shearing head of the hand tool of the present invention.

FIG. 7 is a perspective exploded view of the shearing head of the hand tool of the present invention.

### DETAILED DESCRIPTION OF THE PREFERRED EMBODIMENT

The present invention is a hand tool for shearing a fiber cement workpiece and is generally shown in the Figures as reference numeral 10.

The hand tool 10 further comprises a shearing head 12 having a blade 14 adapted to contact and shear the workpiece W and a coupler 16 connected to the shearing head 12 and imparting reciprocating motion to the blade 14. The shearing head 12 further comprises a skid plate 18 adapted to contact the workpiece W and having an enclosed aperture 20 through which the blade 14 reciprocates. The blade 14 shears the workpiece W against the aperture 20 at a forward portion 20A of the aperture 20.

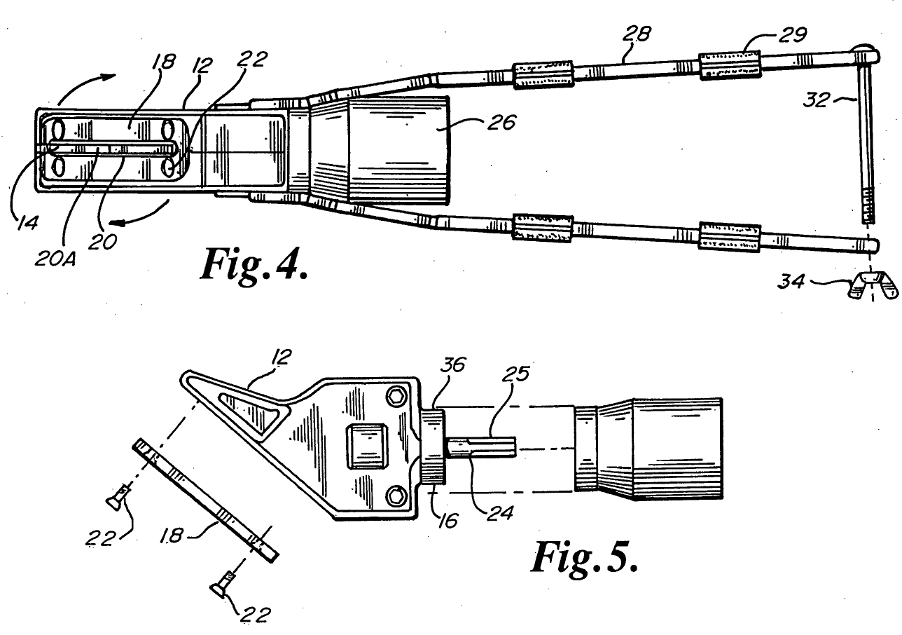

Preferably, the skid plate 18 is reversible as shown by the arrows in FIG. 4 so that the previously rearward portion of the skid plate 18 becomes the forward portion 20A, thus exposing a new surface against which the workpiece may be cut by the blade 14. Thus, the skid plate 18 is preferably rectangular. The skid plate 18 is also removable from the head 12 when it becomes completely worn. To accomplish the above, the skid plate 18 is secured to the head 12 by removable fasteners 22, such as, but not necessarily inclusively, screws.

The coupler 16 further comprises a drive shaft 24 adapted to be connected to the chuck C of a drill D, such as an electric drill, including a portable electric drill. Preferably, the drive shaft 24 has flat portions 25 adapted to prevent the chuck C from slipping.

The hand tool 10 also comprises holding bars 28 adapted to grip and hold the drill D therebetween, and a plurality of pads 29 frictionally gripping the drill D. The holding bars 28 are tightened together by a fastener 30 such as, without being inclusive, a screw 32 and wing nut 34.

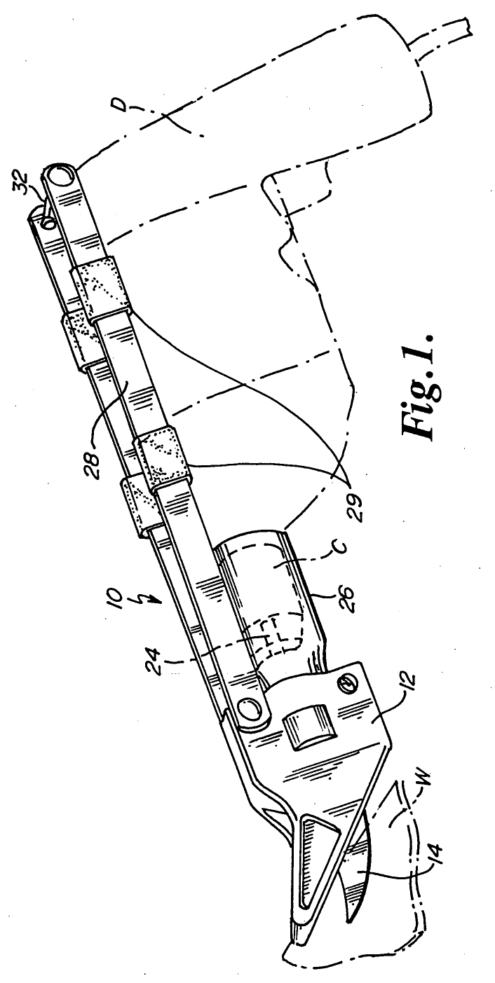

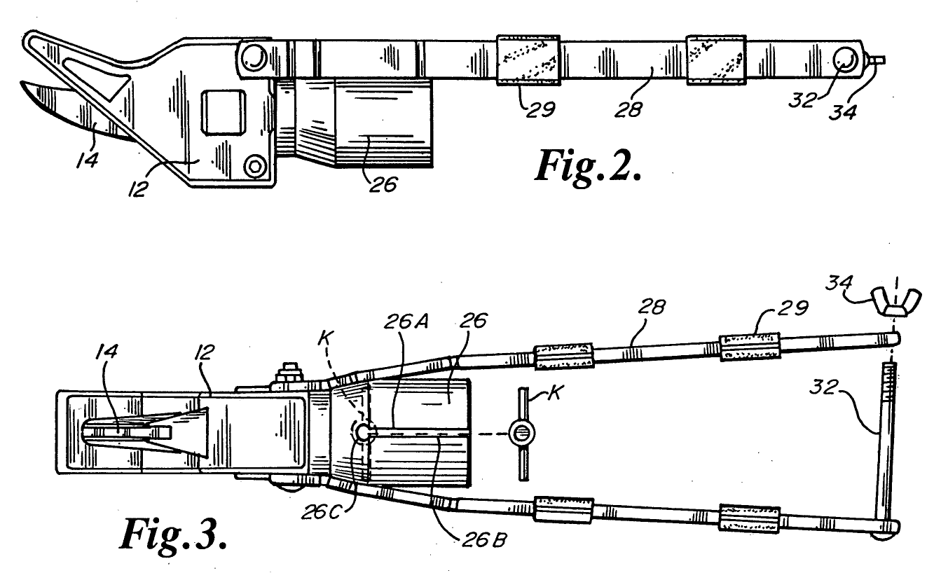

Preferably, the hand tool 10 preferably further comprises a drill guard 26 adapted to receive the chuck C to protect the operator's fingers. It will be seen that as the drill D (shown in phantom in FIG. 1) is inserted between the holding bars 28, it would be possible, without the drill guard 26, for the operator's fingers to become pinched between the chuck C and the holding bars 28.

The drill guard 26 may be constructed of flexible material so that an operator may grip the drill guard 26, forcing the drill guard 26 against the chuck C to turn the chuck C to permit the chuck C to grasp the drive shaft 24. Alternatively, the drill guard 26 may have an aperture 26A (FIG. 3) into which the operator may insert a chuck key K to turn the chuck C to grasp the drive shaft 24. As seen in FIG. 3, the aperture 26A preferably has a slot 26B and a round opening 26C. The operator inserts the shaft of the key K into the slot 26B until the head of the key K rests in the round opening 26C. The key may then be inserted into the chuck C to rotate the chuck.

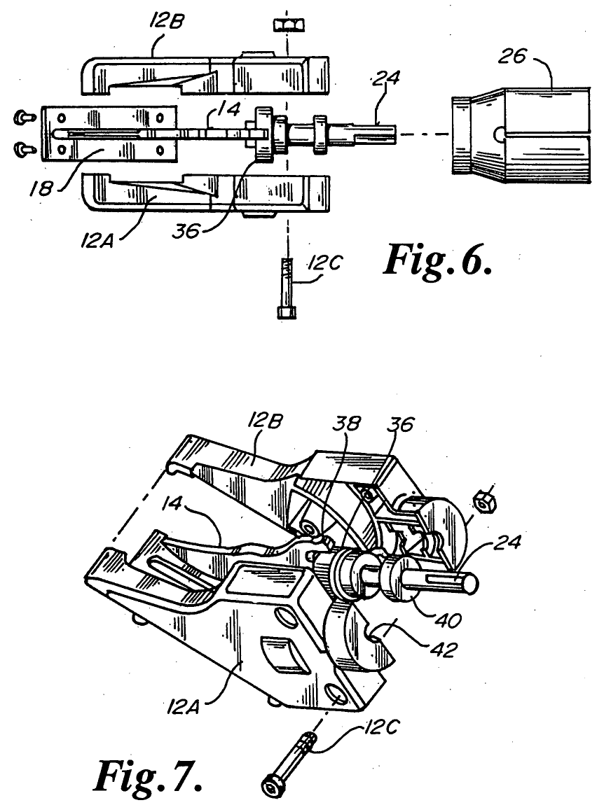

Internal construction of the shearing head 12 is best seen in FIGS. 5, 6, and 7.

The coupler 16 further preferably comprises a bearing cam 36 and the blade 14 further comprises a cam follower 38 engaging the bearing cam 36 for reciprocating motion of the blade, as is known in the art.

The shearing head 12 preferably comprises left 12A and right 12B halves removably connected together by a fastener 12C and enclosing therebetween the blade 14 and bearing cam 36 (FIG. 7).

The coupler may also preferably comprise a roller bearing 40 encompassing the drive shaft 24 and the left and right halves (12A, 12B) of the head 12 form a bearing chase 42 therebetween to encompass the roller bearing 40.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A hand tool for shearing a fiber cement workpiece and attachable to a drill having a drill chuck, the hand tool comprising:
(a) a shearing head having a blade adapted to contact and shear the workpiece; and
(b) a coupler connected to the shearing head and imparting reciprocating motion to the blade;
(c) wherein the shearing head further comprises a skid plate adapted to contact the workpiece and having an enclosed aperture through which the blade reciprocates.

2. The hand tool of claim 1, wherein the enclosed aperture is substantially rectangular.

3. The hand tool of claim 1, wherein the skid plate is removable from the shearing head.

4. The hand tool of claim 3, wherein the skid plate is reversible.

5. The hand tool of claim 1, wherein the blade is removable from the shearing head.

6. The hand tool of claim 1, wherein the coupler further comprises a drive shaft adapted to be connected to the drill chuck.

7. The hand tool of claim 6, wherein the drive shaft has flat portions adapted to prevent the drill chuck from slipping.

8. The hand tool of claim 7, wherein the coupler further comprises a bearing cam and the blade further comprises a cam follower engaging the bearing cam for reciprocating motion of the blade.

9. The hand tool of claim 8, wherein the shearing head further comprises left and right members removably connected together by a fastener and enclosing therebetween the blade and bearing cam.

10. The hand tool of claim 9, wherein the coupler further comprises a drive shaft and a roller bearing encompassing the drive shaft, and wherein the connected left and right members of the shearing head form a bearing chase encompassing the roller bearing.

11. The hand tool of claim 6, further comprising a drill guard surrounding the drive shaft and adapted to receive the drill chuck.

12. The hand tool of clam 11, wherein the drill guard further comprises a flexible material, thereby allowing the operator to grip the drill guard, forcing the drill guard against the drill chuck to turn the drill chuck to permit the drill chuck to grasp the drive shaft.

13. The hand tool of claim 1 1, wherein the drill guard further comprises an aperture allowing the operator to insert a chuck key into the drill chuck to turn the drill chuck to grasp the drive shaft.

14. A hand tool for shearing a fiber cement workpiece and attachable to a drill having a drill chuck for one-handed operation, the hand tool comprising:
(a) a shearing head having a blade adapted to contact and shear the workpiece;
(b) a coupler connected to the shearing head and imparting reciprocating motion to the blade;
(c) wherein the shearing head further comprises a skid plate adapted to contact the workpiece and having an enclosed aperture through which the blade reciprocates; and
(d) means adapted to connect the hand tool to the drill for one-handed operation.

15. The hand tool of claim 14, wherein the enclosed aperture is substantially rectangular.

16. The hand tool of claim 14, wherein the skid plate is removable from the shearing head.

17. The hand tool of claim 16, wherein the skid plate is reversible.

18. The hand tool of claim 14, wherein the blade is removable from the shearing head.

19. The hand tool of claim 14, wherein the coupler further comprises a drive shaft adapted to be connected to the drill chuck.

20. The hand tool of claim 19, wherein the drive shaft has flat portions adapted to prevent the drill chuck from slipping.

21. The hand tool of claim 20, wherein the coupler further comprises a bearing cam and the blade further comprises a cam follower engaging the bearing cam for reciprocating motion of the blade.

22. The hand tool of claim 21, wherein the shearing head further comprises left and right members removably connected together by a fastener and enclosing therebetween the blade and bearing cam.

23. The hand tool of claim 22, wherein the coupler further comprises a drive shaft and a roller bearing encompassing the drive shaft, and wherein the connected left and right members of the shearing head form a bearing chase encompassing the roller bearing.

24. The hand tool of claim 19, further comprising a drill guard surrounding the drive shaft and adapted to receive the drill chuck.

25. The hand tool of clam 24, wherein the drill guard further comprises a flexible material, thereby allowing the operator to grip the drill guard, forcing the drill guard against the drill chuck to turn the drill chuck to permit the drill chuck to grasp the drive shaft.

26. The hand tool of claim 24, wherein the drill guard further comprises an aperture allowing the operator to insert a chuck key into the drill chuck to turn the drill chuck to grasp the drive shaft.
